(19) United States
(12) Patent Application Publication
(10) Pub. No.: US 2026/0249432 A1
(43) Pub. Date: Aug. 27, 2026

(54) IMPACT TOOL

(71) Applicant: VESSEL INDUSTRIAL CO., LTD., Osaka (JP)

(72) Inventors: Jiro TAGUCHI, Osaka (JP); Akihiro NAKAJIMA, Osaka (JP); Shuji YOSHIOKA, Osaka (JP)

(21) Appl. No.: 19/060,976

(22) Filed: Feb. 24, 2025

(51) Int. Cl. B25B 21/02; B25B 23/00

(52) U.S. Cl. CPC B25B 21/02; B25B 23/0035

(57) ABSTRACT

Provided is an impact tool including a motor, a hammer configured to be rotated by the motor, an anvil configured to be struck by the hammer, and a case that houses at least a part of the motor, the hammer, and the anvil. The anvil includes a hammer receiving part, a power transmission part, and a bit supporting part or a socket disposed in this order from a rear side to a front side in an axial direction, the hammer receiving part configured to receive an impact from the hammer, the power transmission part configured to transmit a power received by the hammer receiving part to the front side, the bit supporting part or the socket configured to be rotated by receiving the power from the power transmission part. The bit supporting part and the power transmission part are connected with each other with a play therebetween in a rotational direction.

### TECHNICAL FIELD

The present invention relates to an impact tool such as an impact driver, an impact wrench, or an impact ratchet.

### BACKGROUND

There is hitherto known an impact type screw fastener that includes a hammer and an anvil, and is configured such that the hammer is rotated using the power of a motor, and the rotating hammer strikes the anvil, thereby applying a rotational impact force to a screwing bit attached to the anvil (see JP 4754395 B).

In this impact type screw fastener, every time the hammer strikes the anvil, the striking force is transmitted to the user's hand, causing discomfort to the user, and hence there is room for improvement.

### SUMMARY OF THE INVENTION

An object of the present invention is to provide an impact tool which is easy to use and in which striking force is not easily transmitted.

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

An impact tool of the present disclosure includes a motor, a hammer configured to be rotated by the motor, an anvil configured to be struck by the hammer, and a case that houses at least a part of the motor, the hammer, and the anvil, the anvil including a hammer receiving part, a power transmission part, and a bit supporting part or a socket disposed in this order from a rear side to a front side in an axial direction, the hammer receiving part configured to receive an impact from the hammer, the power transmission part configured to transmit a power received by the hammer receiving part to the front side, the bit supporting part or the socket configured to be rotated by receiving the power from the power transmission part, the bit supporting part and the power transmission part being connected with each other with a play therebetween in a rotational direction.

In the impact tool, the power transmission part and the bit supporting part or the socket can be made of different materials or have different hardnesses.

The impact tool can be configured to further include an intermediate part, in which a side surface of the power transmission part and an inner surface of a stationary part located on an outer side in a radial direction of the power transmission part and fixed to the case form therebetween a space for disposing the intermediate part, and the space includes a moving area for enabling the intermediate part to move in a circumferential direction, and an engagement area for enabling the intermediate part to be engaged with the side surface of the power transmission part and the inner surface of the stationary part.

The impact tool can be configured such that the bit supporting part has a substantially cylindrical shape having the same outer diameter at the same axial position.

The impact tool can be configured such that a front end part of the power transmission part is inserted into and connected with a rear end part in the axial direction of the bit supporting part, and the rear end part in the axial direction of the bit supporting part has a size larger in the radial direction than the other part of the bit supporting part.

### EFFECT OF THE INVENTION

According to this disclosure, it is possible to provide an impact tool which is easy to use and in which striking force is not easily transmitted.

### BRIEF DESCRIPTION OF DRAWINGS

The foregoing and other features of the present disclosure will become apparent from the following detailed description and drawings of illustrated embodiments of the present disclosure.

FIG. 1 is a side view of an impact driver, a part of which is cross sectioned.

FIG. 2 is an exploded perspective view of parts forming an impact mechanism part mounted in a case.

FIG. 3 is a side view of the impact mechanism part.

FIG. 4 is a cross sectional view as seen from a rear side, showing the state where a motor is rotated in a forward direction in an unlocked state.

FIG. 5 is a cross sectional view as seen from the rear side, showing a locked state at the time of manual fastening.

FIG. 6 is a cross sectional view as seen from the rear side, showing a locked state at the time of manual returning (unfastening).

FIG. 7 is a cross sectional view as seen from the rear side, showing the state immediately before releasing the locked state by reversely rotating the motor.

FIG. 8 is a cross sectional view of a main part of another form of a power transmission part as seen from the rear side, showing another form of the power transmission part.

FIG. 9 is a cross sectional view orthogonal to the axial direction at a connection position between a front end portion of the power transmission part and a large diameter part of a bit supporting part according to another embodiment.

FIG. 10 is a cross sectional view orthogonal to the axial direction at a connection position between the front end portion of the power transmission part and the large diameter part of the bit supporting part according to still another embodiment.

FIG. 11 is a cross sectional view orthogonal to the axial direction at a connection position between the front end portion of the power transmission part and the large diameter part of the bit supporting part according to yet another embodiment.

### DESCRIPTION OF EMBODIMENTS

Hereinafter, an impact driver as an impact tool of the present invention will be described with reference to the drawings.

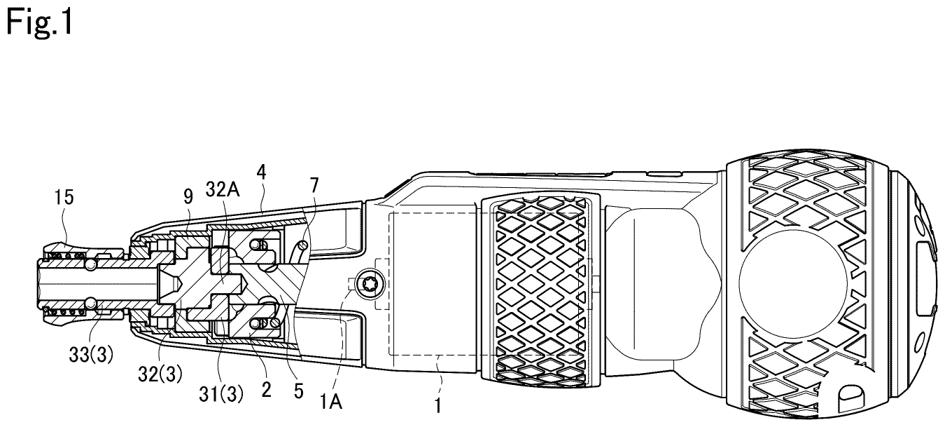

As shown in FIG. 1, an impact driver of the present invention includes a motor 1 having an output shaft 1A that rotates, a hammer 2 configured to be rotated by the motor 1, an anvil 3 configured to be struck by the hammer, and a case 4 that houses at least a part of the motor 1, the hammer 2, and the anvil 3. The case 4 may be configured to be composed of two separate cases separated into right and left (or upper and lower) cases. The impact driver is of a battery type that is rotated by the motor 1 using a battery (not shown) such as a secondary battery supplying electric power, but may be configured to be rotated by the motor 1 using electric power from a commercial AC power supply. The description will be made with a left side (leading end) and a base end (right end) of the impact driver referred respectively as a proximal side (front side) and a distal side (rear side).

The impact driver of FIG. 1 has a substantially cylindrical shape extending straight from the front end at which a bit supporting part 33 is disposed to the rear end at which a battery or the like is housed. The impact driver having such a substantially cylindrical shape enables itself to be securely housed in a driver sack carried at the waist of a worker, and to be easily taken out and put back into the driver sack, which is excellent in portability. Contrarily to this, when an impact driver has a substantially L-shape having a body part in which a motor or a rotary impact mechanism part is housed, and a grip part which is mounted to a rear end part of the body part and extends in a direction crossing the body part and in which a battery or the like is housed, the grip part protrudes outward from the driver sack in the state in which the worker puts the impact driver into the driver sack. This configuration causes the protruding grip part to hit against an object when the worker walks, or causes the protruding grip part to hit against an object and hence the impact driver itself to fall from the driver sack, which is disadvantageous.

The impact driver (impact tool) has an impact mechanism part for increasing the fastening force against a screw by striking the anvil 3 with the hammer 2. Vibrations generated at the impact mechanism part result from the impacts between metals, and each impact generates vibrations. The hammer 2 is biased in the axial direction by a later-described coil spring 7 so that when the anvil 3 is subjected to a certain load or more, the hammer 2 is moved in the axial direction against the biasing force of the coil spring 7. When the hammer 2 moves by a certain distance or more, the hammer 2 becomes rotatable relative to the anvil 3 and hence is struck against the anvil 3 by the biasing force of the coil spring 7. The impact driver (impact tool) having such a configuration generates vibrations in a rotating direction in which the fastening force against the screw is increased, when the hammer 2 strikes the anvil 3 in the rotating direction, while generating vibrations in the axial direction, which act in the axial direction of the anvil 3. This causes large vibrations.

The anvil 3 has a hammer receiving part 31, a power transmission part 32, and the bit supporting part 33 disposed in this order from the rear side to the front side in the axial direction, the hammer receiving part configured to receive impacts from the hammer 2, the power transmission part configured to transmits power received by the hammer receiving part 31 to the front side, the bit supporting part 33 configured to support a bit (not shown) that is rotated by receiving the power from the power transmission part 32.

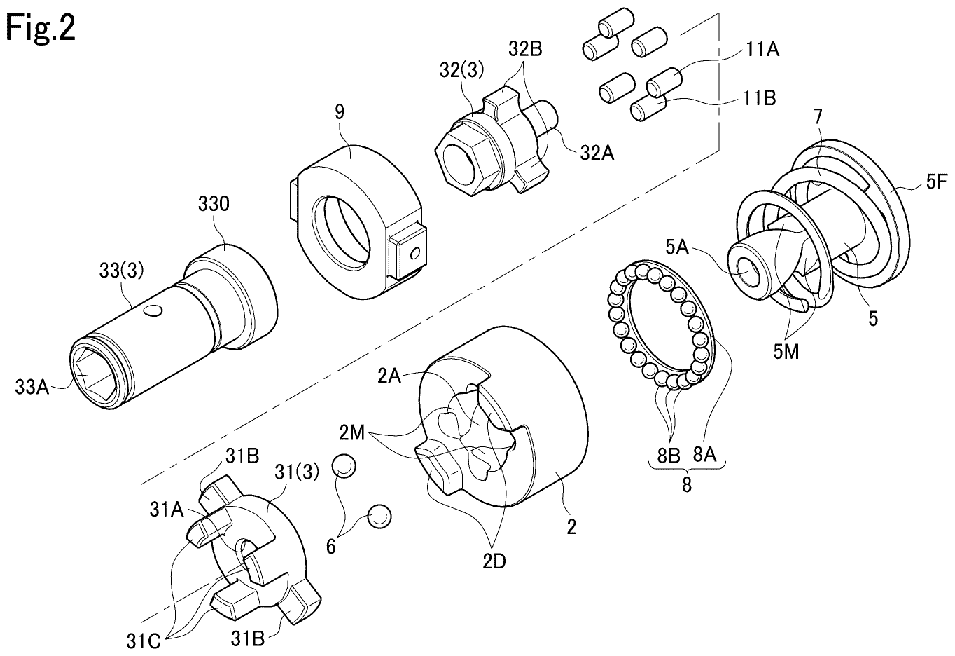

The output shaft 1A of the motor 1 is connected to a planetary gear reduction mechanism (not shown), the output of which is transmitted to a driving shaft 5 to thereby cause the driving shaft 5 to rotate. As shown in FIG. 2, a rear end part of a coupling part 32A having a cylindrical shape and extending rearward from a rear end of the power transmission part 32 is fitted into a fitting hole 5A formed in a front end part of the driving shaft 5 so that the driving shaft 5 is integrally rotatably connected with the power transmission part 32.

As shown in FIG. 2, the hammer 2 has a through hole 2A through which the driving shaft 5 passes. Steel balls 6,6 are held between engagement grooves 2M, 2M formed in this through hole 2A and engagement grooves 5M, 5M formed on an outer circumferential surface of the driving shaft 5. This configuration allows the hammer 2 to be movable relative to the driving shaft 5 in the axial direction (front-back direction) of the drive shaft 5, and rotatable relative to the driving shaft 5. Striking parts 2D, 2D which project forward are disposed respectively at two places of an outer circumferential part on a front surface of the hammer 2. The striking parts 2D, 2D are formed respectively at two positions equally spaced along the circumference of the hammer 2.

The driving shaft 5 includes a flange 5F having a disk shape and disposed at the rear end. A coil spring 7 is disposed between the flange 5F and the hammer 2 to bias the hammer 2 to the front side. A sliding member 8 is disposed between the front end of the coil spring 7 and the hammer 2 to allow the coil spring 7 to be rotatable relative to the hammer 2. The sliding member 8 includes a plate member 8A having a ring shape to receive a front end of the coil spring 7, and a large number of balls 8B interposed between the plate member 8A and the hammer 2 along the circumferential direction.

As shown in FIG. 2, the hammer receiving part 31 has a through hole 31A through which the coupling part 32A of the power transmission part 32 passes, and is held by the power transmission part 32 to be movable relative to the power transmission part 32 within a certain range. Impact receiving parts 31B, 31B projecting outward in the radial direction to receive impacts from the striking parts 2D, 2D of the hammer 2 are disposed at two positions equally spaced along the circumference of an outer circumferential part of the hammer receiving part 31.

Transmission parts 31C, 31C, 31C (see FIG. 2) for transmitting the power to the power transmission part 32 project forward at three positions equally spaced along the circumference on the front surface of the outer circumferential part of the hammer receiving part 31.

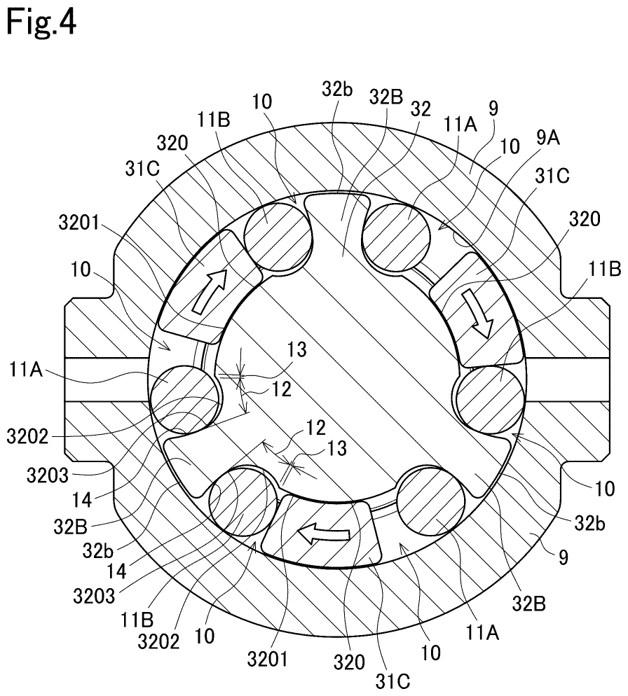

As shown in FIG. 4, power receiving parts 32B project outward in the radial direction at three positions equally spaced along the circumference on the outer circumferential surface of the rear end part of the power transmission part 32. Each of the power receiving part 32B is located between each adjacent two transmission parts 31C, 31C in the circumferential direction. The power transmission part 32 has an outer circumferential surface 320 between the two adjacent power receiving parts 32B, 32B in the circumferential direction, and has three outer circumferential surfaces 320, 320, 320 in total. The power transmission part 32 has a hardness lower than the hardness of the striking parts 2D, 2D of the hammer 2, the hardness of the hammer receiving part 31, and the hardness of the bit supporting part 33. For example, the hardness (Rockwell hardness) of the power transmission part 32 is 40 HRC, and the hardnesses (Rockwell hardness) of the striking parts 2D, 2D of the hammer 2, the hammer receiving part 31 and the bit supporting part 33 each are 48 HRC. In this embodiment, the hardnesses of the striking parts 2D, 2D of the 2 hammer 2, the hammer receiving part 31 and the bit supporting part 33 are the same as each other, but can be different from each other. When the hardness of the power transmission part 32 is set to be lower than the hardness of the hammer receiving part 31, vibrations are unlikely to be transmitted from the hammer receiving part 31 to the power transmission part 32. Further, when the hardness of the power transmission part 32 is set to be lower than the hardness of the bit supporting part 33, vibrations are unlikely to be transmitted from the power transmission part 32 to the bit supporting part 33. Thus, vibrations transmitted to the user's hand can be reduced. Thereby, vibrations are unlikely to be transmitted to the hand even when the user grips the case 4 near the motor 1 to which vibrations of the motor 1 are additionally applied.

As shown in FIG. 1 and FIG. 4, disposed on the outer side of the power receiving parts 32B, 32B, 32B of the power transmission part 32 is a locking part 9 having a ring shape and surrounding the power receiving parts 32B, 32B, 32B. The locking part 9 is non-rotatably fixed to the case 4. A small clearance is formed between an inner circumferential surface 9A of the locking part 9 and outer surfaces 32b, 32b, 32b of the power receiving parts 32B, 32B, 32B so as not to interfere the rotation of the power transmission part 32.

A space 10 is formed between each of the power receiving parts 32B, 32B, 32B and each of the transmission parts 31C, 31C, 31C located on both sides of each of the power receiving parts 32B, 32B, 32B in the circumferential direction. 6 spaces 10 are formed in total. Intermediate parts 11A, 11B are respectively located in these 6 spaces 10. The intermediate parts 11A, 11B have a shape enabling rotation in the circumferential direction, specifically a cylindrical column shape (or spherical shape) that rotate and move in the circumferential direction. The axial direction of the rotational center of the intermediate parts 11A, 11B when moving in the circumferential direction is parallel to the axis of the driving shaft 5. When the transmission parts 31C, 31C, 31C are rotated in the direction of arrows (clockwise direction) by driving the motor 1 in the forward direction, as shown in FIG. 4, the transmission parts 31C, 31C, 31C abut against the three intermediate parts 11B, 11B, 11B, and thereby the intermediate parts 11B, 11B, 11B further abut against the power receiving parts 32B, 32B, 32B. Thereby, the rotational forces of the transmission parts 31C, 31C, 31C are transmitted to the power receiving parts 32B, 32B, 32B via the intermediate parts 11B, 11B, 11B, and thereby the power transmission part 32 is rotated to rotate the bit supporting part 33 in the forward direction. When the transmission parts 31C, 31C, 31C are rotated in an opposite direction to the direction of the arrows in FIG. 4 (anti-clockwise direction) by driving the motor 1 in a reverse direction that is the opposite direction to the forward direction, the transmission parts 31C, 31C, 31C abut against the three intermediate parts 11A, 11A, 11A on the opposite side to the intermediate parts located on the downstream side in the rotational direction, and thereby the three intermediate parts 11A, 11A, 11A further abut against the power receiving parts 32B, 32B, 32B. Thereby, the rotational forces of the transmission parts 31C, 31C, 31C are transmitted to the power receiving parts 32B, 32B, 32B via the intermediate parts 11A, 11A, 11A, and thereby the power transmission part 32 is rotated to rotate reversely the bit supporting part 33.

As shown in FIG. 4, each space 10 has a moving area 12 in which a corresponding one of the intermediate parts 11A, 11B is movable in the circumferential direction, and an engagement area 13 in which the corresponding one of the intermediate parts 11A, 11B is engaged between an outer circumferential surface 320 of the power transmission part 32 and an inner circumferential surface 9A of the locking part 9 and thereby the corresponding one of the intermediate parts 11A, 11B becomes non-rotatable in the circumferential direction.

The engagement area 13 is formed at each of both ends in the circumferential direction of a center outer circumferential surface 3201 formed of a curved surface that is located at a center in the circumferential direction of each of the outer circumferential surfaces 320 and is outwardly convex. The moving area 12 is formed between an end on the side of the power receiving part 32B of the engagement area 13 and an abutting surface 14 against which a corresponding one of the intermediate parts 11A, 11B of the power receiving part 32B abuts. Specifically, the moving area 12 has an end-part outer circumferential surface 3202 that is formed in the outer circumferential surface 320 of the power transmission part 32 to be inwardly convex, and an extension outer circumferential surface 3203 that is formed of a curved surface to be inwardly convex continuously from the end on the side of the power receiving part 32B of the end-part outer circumferential surface 3202 to the abutting surface 14 of the power receiving part 32B.

The moving area 12 having the end-part outer circumferential surface 3202 formed in the outer circumferential surface 320 of the power transmission part 32 to be inwardly convex can increase the size of the space 10 in the radial direction so that it is possible to produce the intermediate parts 11A, 11B with a large diameter, which is advantageous in terms of the power transmission. Thus, it is possible to improve the degree of freedom in designing. In addition, the moving area 12 having the extension outer circumferential surface 3203 formed continuously from the end on the side of the power receiving part 32B of the end-part outer circumferential surface 3202 to the abutting surface 14 of the power receiving part 32B allows the intermediate parts 11A, 11B to abut against the power receiving part 32B by surface-to-surface contact, which enables impact force applied from the intermediate parts 11A, 11B to the power receiving part 32B to be dispersed.

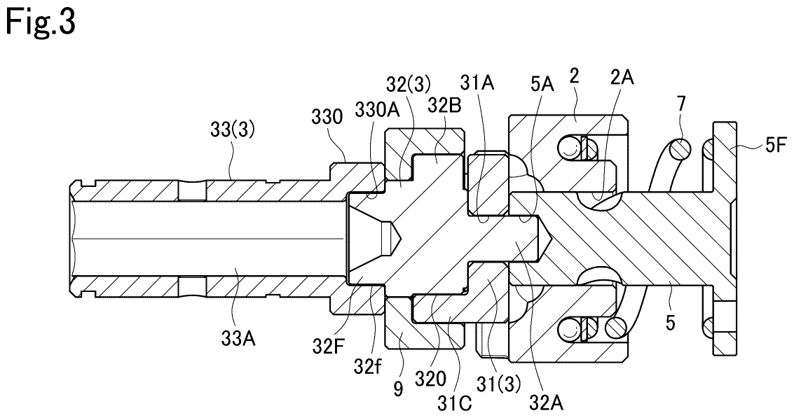

The bit supporting part 33 has an insertion hole 33A having a hexagonal shape as seen from the front side (see FIG. 2, FIG. 3), into which a bit (not shown) can be inserted, and is formed into a substantially cylindrical shape with a constant diameter at any positions in the same axial direction. The bit supporting part 33 having a substantially cylindrical shape with a constant diameter at positions in the same axial direction can have a strength constant in the circumferential direction.

As shown in FIG. 2 and FIG. 3, the bit supporting part 33 has a large diameter part 330 at the rear end part in the axial direction which is larger than the other part of the bit supporting part 33. The bit supporting part 33 having the rear end part in the axial direction which is larger than the other part can more ensure the thickness than the other part, which is advantageous because the rotational force from the power transmission part 32 can be securely transmitted to the bit supporting part 33. The large diameter part 330 has an inner surface 330A formed into a regular hexagonal shape, into which a regular hexagonal shaped front end part 32F of the power transmission part 32 can be inserted, so that both parts can be connected with each other.

As shown in FIG. 3, an inner diameter of the large diameter part 330 (inner diameter of an area surrounded by the inner surface 330A) is set to be larger than the outer diameter of an outer surface 32f of a front end part 32F of the power transmission part 32. Thereby, there is provided a play in the rotational direction between the inner surface 330A of the large diameter part 330 and the outer surface 32f of the front end part 32F of the power transmission part 32.

The inner surface 330A of the large diameter part 330 has a polygonal shape as seen in the axial direction, and the outer surface 32f of the front end part 32F of the power transmission part 32 has a polygonal shape corresponding to the inner surface 330A, as seen in the axial direction. More specifically, the inner surface 330A of the large diameter part 330 has a regular polygonal shape as seen in the axial direction, and the outer surface 32f of the front end part 32F of the power transmission part 32 has a regular polygonal shape with the same number of angles as that of the inner surface 330A as seen in the axial direction.

The length (maximum outer diameter) connecting two apexes opposing to each other of the outer surface 32f of the front end part 32F in the power transmission part 32 is smaller than the length (maximum inner diameter) connecting two apexes opposing to each other of the inner surface 330A of the large diameter part 330, and is larger than the length (maximum inner diameter) connecting two sides opposing to each other of the inner surface 330A of the large diameter part 330. Specifically, for example, the length (maximum inner diameter) connecting to apexes opposing to each other of the inner surface 330A of the large diameter part 330 is 9.14 mm, and the length (minimum inner diameter) connecting two sides opposing to each other of the inner surface 330A of the large diameter part 330 is 8.00 mm, while the length (maximum outer diameter) connecting two apexes opposing to each other of the outer surface 32f of the front end part 32F in the power transmission part 32 is 8.97 mm, and the length (minimum outer diameter) connecting two sides opposing to each other of the outer surface 32f of the front end part 32F in the power transmission part 32 is 7.90 mm.

In this configuration, for example, when the power transmission part 32 rotates around the axis, each of the apexes of the outer surface 32f of the front end part 32F in the power transmission part 32 rotates relative to the large diameter part 330 of the power transmission part 32 until each of the apexes abuts against the inner surface 330A of the large diameter part 330. That is, the rotation of the power transmission part 32 relative to the large diameter part 330 is permitted. After each of the apexes of the outer surface 32f of the front end part 32F in the power transmission part 32 abuts against a corresponding one of the sides of the inner surface 330A of the large diameter part 330, the power transmission part 32 and the large diameter part 330 integrally rotate. In other words, the front end part 32F and the large diameter part 330 are connected with each other so that after a small relative rotation is permitted at the start of the rotation of one of the front end part 32F and the large diameter part 330, both integrally rotate.

The configuration that the bit supporting part 33 and the power transmission part 32 are connected with each other with a play therebetween in the rotational direction prevents vibrations generated by the impact force of the hammer receiving part 31 which receives the impacts from the hammer 2 from easily transmitting from the power transmission part 32 to the bit supporting part 33. Thus, vibrations transmitted to the user's hand can be reduced.

A chuck 15 (see FIG. 1) is disposed on the outside of the bit supporting part 33 to allow a bit (not shown) inserted into the bit supporting part 33 to be fixed therein in a detachable manner.

The bit supporting part 33 and the power transmission part 32 are made of different materials. Specifically, the bit supporting part 33 is formed by a forging process using iron or a forging material including iron as a main component, which achieves an enhanced productivity. The power transmission part 32 is formed by an injection molding process using iron based alloy powder or copper based alloy powder, which can enhance processing accuracy. When the bit supporting part 33 and the power transmission part 32 are allowed to be made of different materials, it is possible to easily select the material of each of the bit supporting part 33 and the power transmission part 32.

At the time of screw fastening or unfastening operation by driving the motor 1, the intermediate parts 11A, 11B are functioned as transmission members for transmitting the rotational force from the transmission parts 31C, 31C, 31C to the power receiving part 32B, and at the time of additional screw fastening or screw unfastening by manual operation, the intermediate parts 11A, 11B are engaged between the power transmission part 32 and the locking part 9 to be functioned as locking members for locking the rotation of the power transmission part 32.

When the additional screw fastening operation is made by driving the motor 1 of the impact driver, the motor 1 is driven in the forward direction to rotate the transmission parts 31C, 31C, 31C in the clockwise direction (direction of the arrows), as shown in FIG. 4, the transmission parts 31C, 31C, 31C abut against the three intermediate parts 11B, 11B, 11B located on the downstream side of the rotational direction, and the three intermediate parts 11B, 11B, 11B further abut against the power receiving parts 32B, 32B, 32B. Thereby, the rotational forces of the transmission parts 31C, 31C, 31C are transmitted to the power receiving parts 32B, 32B, 32B via the intermediate parts 11B, 11B, 11B, and thereby the power transmission part 32 rotates to rotate the bit supporting part 33 in the forward direction. At this time, the remaining three intermediate parts 11A, 11A, 11A, to which the driving power is not transmitted, are located in the moving area 12 so as not to interfere the rotation of the power transmission part 32. When the screw unfastening operation is made by the impact driver, the same operation is performed as the rotation in the forward direction except that the rotational direction of the motor 1 becomes the opposite direction (anti-rotational direction). Thus, the description for it will be omitted.

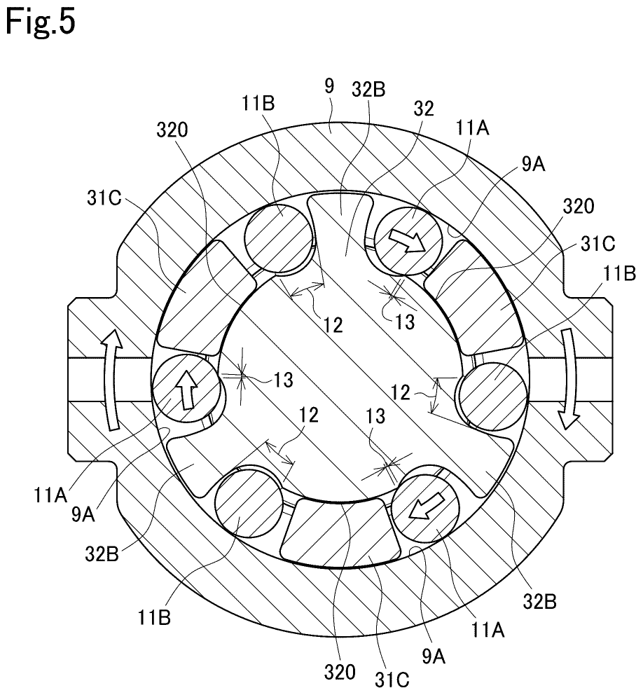

When the screw additional fastening is made by manual operation, as shown in FIG. 5, the case 4 (not the case 4, but the locking part 9 fixed to the case 4 in FIG. 5) is rotated in the clockwise direction as represented by the arrows in the state in which the driving of the motor 1 is stopped, each intermediate part 11A on the upstream side in the rotational direction among the intermediate parts 11A, 11B located on both sides in the circumferential direction of each transmission part 31C is made to rotate by the rotation of the case 4 (fixing part 9) and move to the engagement area 13 on the downstream side in the rotational direction, and the intermediate part 11A is engaged with the outer circumferential surface 320 of the power transmission part 32 and the inner circumferential surface 9A of the locking part 9. Thereby, the rotation of the power transmission part 32 is locked, and the case 4 is rotated in the clockwise direction by hand so that the screw additional fastening can be operated. At this time, each intermediate part 11B located on the downstream side in the rotational direction among the intermediate parts 11A, 11B is kept positioned in the moving area 12.

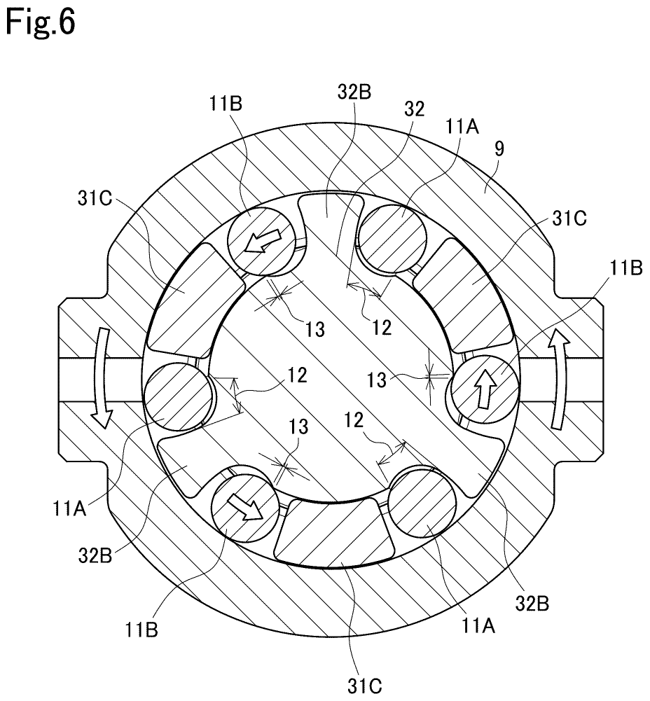

When the additional screw tightening is made by manual operation, as shown in FIG. 6, the case 4 (not the case 4, but the locking part 9 fixed to the case 4 in FIG. 6) is rotated in the anti-clockwise direction as represented by the arrows in the state where the driving of the motor 1 is stopped, each of the intermediate part 11B on the upstream side in the rotational direction among the intermediate parts 11A, 11B located on both sides in the circumferential direction of each of the transmission parts 31C is made to rotate by the rotation of the case 4 moves to the engagement area 13 on the downstream side in the rotational direction, and the intermediate part 11B is engaged with the outer circumferential surface 320 of the power transmission part 32 and the inner circumferential surface 9A of the locking part 9. Thereby, the rotation of the power transmission part 32 is blocked, and the case 4 is rotated in the anti-clockwise direction by hand so that the screw loosening can be made. At this time, the intermediate part 11A located on the downstream side in the rotational direction among the intermediate parts 11A, 11B is kept positioned in the moving area 12.

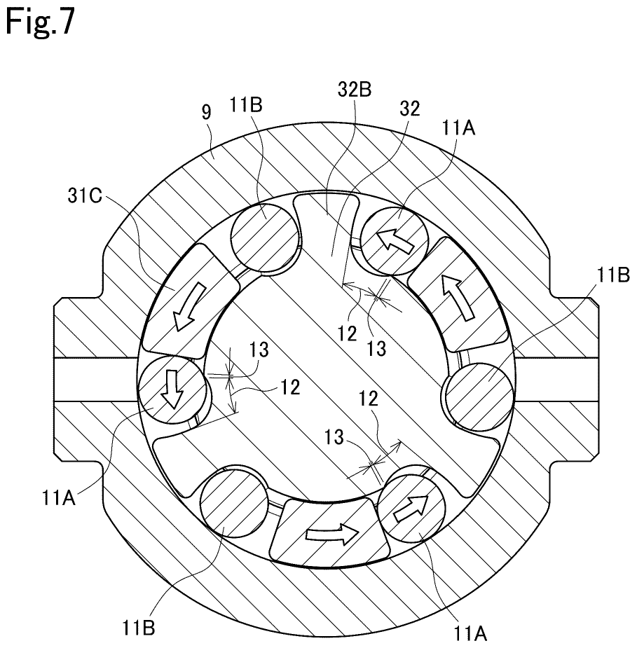

When it is desired to release each intermediate part 11A from the engagement with the outer circumferential surface 320 of the power transmission part 32 and the inner circumferential surface 9A of the locking part 9 as shown in FIG. 5, the motor 1 is reversely rotated (rotated in the anti-clockwise direction) to move each intermediate part 11A to the moving area 12 as shown in FIG. 7.

The present invention is not limited to the above embodiment, and various modifications can be made without departing from the gist of the present invention.

The impact driver is described as an impact tool in the above embodiment, but an impact wrench or impact ratchet may also be used. When the impact wrench or impact ratchet is used, a socket having a hexagonal or dodecagonal hole for fitting onto a bolt or nut to perform a tightening or loosening operation is connected to the power transmission part instead of the bit supporting part of the impact driver.

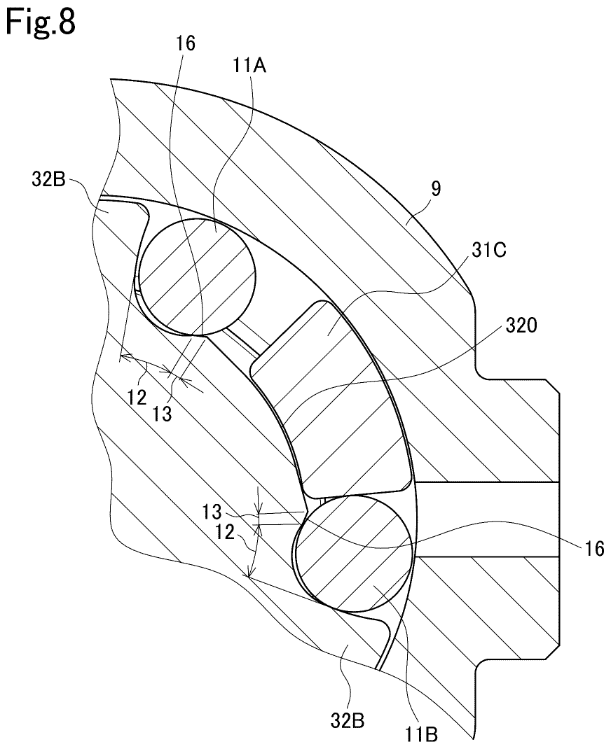

In the above embodiment, the engagement area 13 is defined in a narrow range of a boundary between each of the inwardly convex moving areas 12, 12 and the outer circumferential surface 320 formed of an outwardly convex curved surface, but as shown in FIG. 8, the configuration can be made such that a straight part 16 having a certain length in the circumferential direction is formed between the moving area 12 and the outer circumferential surface 320, and the straight part 16 is served as the engagement area 13. Such a configuration enables the intermediate parts 11A or 11B to be securely engaged with the straight part 16.

In the connection portion between the power transmission part 32 and the bit supporting part 33 in the above embodiment, the outer surface 32f of the front end part 32F of the power transmission part 32 has a regular polygonal shape as seen in the axial direction, and the inner surface 330A of the large-diameter part 330 of the bit supporting part 33 has a regular polygonal shape as seen in the axial direction. However, the shape of the outer surface 32f of the front end part 32F and the shape of the inner surface 330A of the large-diameter part 330 are not limited to the regular polygonal shape.

The outer surface 32f of the front end part 32F of the power transmission part 32 and the inner surface 330A of the large-diameter part 330 of the bit supporting part 33 can have any shape as long as they are non-circular as seen in the axial direction.

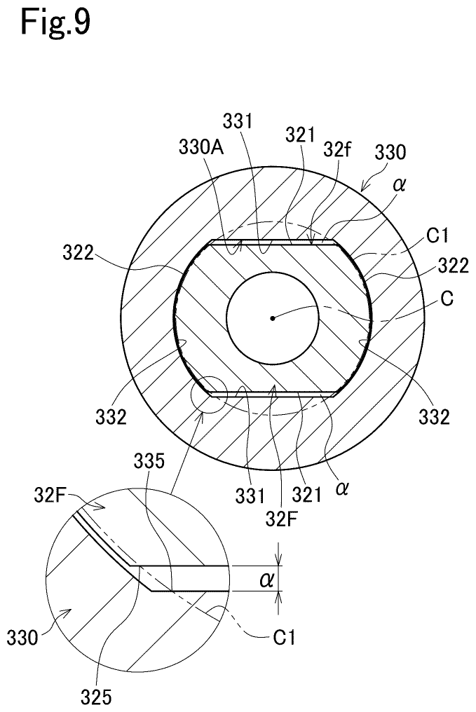

For example, as shown in FIG. 9, the outer surface 32f of the front end part 32F can have a shape with a pair of parallel sides 321 with a rotational center C of the power transmission part 32 therebetween, and a pair of arc parts 322 connecting the end pars of the pair of parallel sides 321, as seen in the axial direction. In this case, the inner surface 330A of the large-diameter part 330 has the same shape as the outer surface 32f, that is, the shape with a pair of side parts 331 with the rotational center C of the power transmission part 32 therebetween, and a pair of arc parts 332 connecting end parts of the pair of parallel sides 321, and clearances α between the sides 321 of the inner surface 330A and the sides 331 of the outer surface 32f. It is not necessary that the parallel sides opposing to each other with the rotational center C of the power transmission part 32 therebetween, and the arc parts 332 opposing to each other with the rotational center C of the power transmission part 32 therebetween each are limited to a single pair. It can be configured to include a plurality of pairs of the sides 321 and a plurality of pairs of the arc parts 332. That is, the outer surface 32f of the front end part 32F and the inner surface 330A of the large-diameter part 330 each can have a plurality of pairs of the sides 321, and a plurality of pairs (the same number of pairs as the pair of sides 321) of the arc parts 332, as seen in the axial direction.

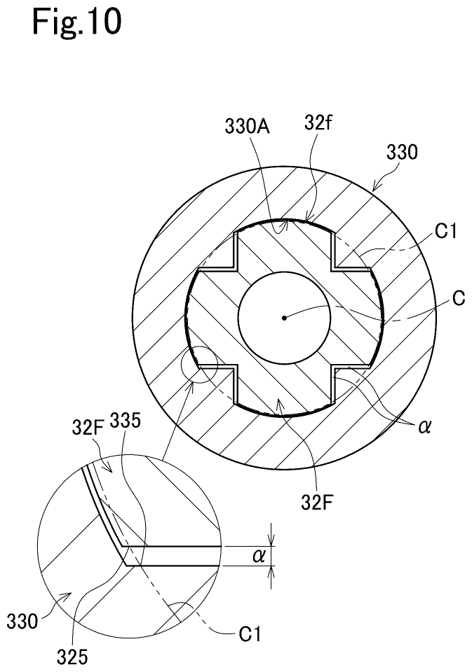

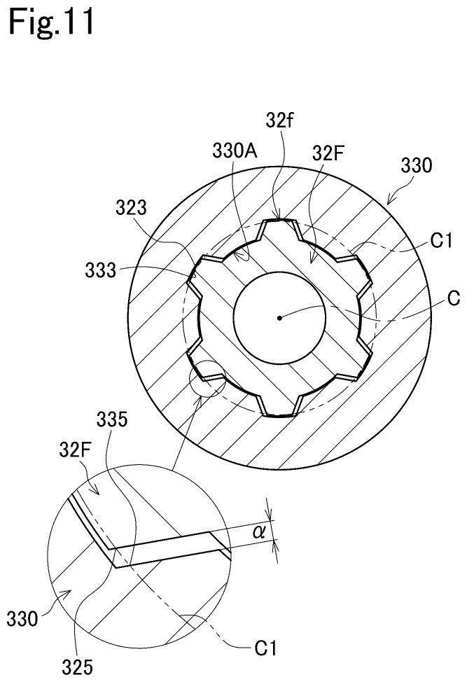

As shown in FIG. 10, the outer surface 32f of the front end part 32F and the inner surface 330A of the large-diameter part 330 each can have a cross shape as seen in the axial direction, and it can be configured such that as shown in FIG. 11, the outer surface 32f of the front end part 32F has a plurality of projection parts 323 projecting outward (in the direction away from the rotational center C) located in the circumferential direction as seen in the axial direction, and the inner surface 330A of the large-diameter part 330 has a plurality of recessing parts 333 recessing outward as seen in the axial direction, and configured to fit onto each corresponding one of the projection parts 323 on the outer surface 32f. Any shape including these shapes can be employed, provided that the portions 323, 335 crossing a circle C1 with the rotational center C of the outer surface 32f and the inner surface 330A as a center oppose each other with a clearance (space) α therebetween. It can be configured such that the inner surface 330A of the large-diameter part 330 has the projection parts 323, and the outer surface 32f of the front end part 32F has the recessing parts 333.

That is, it can be configured such that the outer surface 32f of the front end part 32F of the power transmission part 32 and the inner surface 330A of the large-diameter part 330 respectively have the portions (opposing portions) 325, 335 that extend in the direction crossing the circle C and oppose each other with the clearance α therebetween (see FIG. 9 to FIG. 11), and when the power transmission part 32 rotates around the axis, the power transmission part 32 can rotate relative to the large-diameter part 330 until the opposing portions 324, 335 contact each other, and after the opposing portions 325, 335 contact each other, the large-diameter part 330 rotates together with the power transmission part 32.

With the outer surface 32f of the front end part 32F of the power transmission part 32 and the inner surface 330A of the large-diameter part 330 of the bit supporting part 33 having the shapes described above, the front end part 32F and the large-diameter part 330 contact each other so that after a small relative rotation is permitted at the start of the rotation of one of the front end part 32F and the large-diameter part 330, both of them integrally rotate. That is, the bit supporting part 33 and the power transmission part 32 are connected with each other with a play in the rotational direction.

The following presents a brief summary of the present invention in order to provide a basic understanding of some aspects of the present invention. This summary is not intended to outline the outer boundary of the present invention. It is not intended to identify key or critical elements of the present invention or to delineate the scope of the present invention. Its sole purpose is to present some basic concepts of the invention in a simplified form as a prelude to a more detailed description that follows.

An impact tool of the present disclosure includes a motor, a hammer configured to be rotated by the motor, an anvil configured to be struck by the hammer, and a case that houses at least a part of the motor, the hammer, and the anvil, the anvil including a hammer receiving part, a power transmission part, and a bit supporting part or a socket disposed in this order from a rear side to a front side in an axial direction, the hammer receiving part configured to receive an impact from the hammer, the power transmission part configured to transmit a power received by the hammer receiving part to the front side, the bit supporting part or the socket configured to be rotated by receiving the power from the power transmission part, the bit supporting part and the power transmission part being connected with each other with a play therebetween in a rotational direction.

This configuration that the power transmission part and the bit supporting part are connected with each other with a play in the rotational direction allows vibrations generated by the impact force of the hammer receiving part which receives impacts from the hammer to be hardly transmitted from the power transmission part to the bit supporting part or the socket. Thus, it is possible to reduce vibrations transmitted to the user's hand.

In the impact tool, the power transmission part and the bit supporting part or the socket can be made of different materials or have different hardnesses.

According to this configuration, it is possible to easily select the material(s) of the power transmission part and the bit supporting part or the socket. For example, when the hardness of the power transmission part is set to be lower than the hardness of the bit supporting part or the socket, it is possible to further reduce vibrations transmitted to the user's hand.

The impact tool can be configured to further include an intermediate part, in which a side surface of the power transmission part and an inner surface of a stationary part located on an outer side in a radial direction of the power transmission part and fixed to the case form therebetween a space for disposing the intermediate part, and the space includes a moving area for enabling the intermediate part to move in a circumferential direction, and an engagement area for enabling the intermediate part to be engaged with the side surface of the power transmission part and the inner surface of the stationary part.

According to this configuration, the power transmission part and the bit supporting part are fixed to the case by the intermediate parts coming into the engaged state in the engagement areas. Thereby, when the case is rotated by hand to rotate the bit mounted to the bit supporting part, the screw can be additionally tightened.

The impact tool of the present disclosure can be configured such that the bit supporting part has a substantially cylindrical shape having the same outer diameter at the same axial position.

The configuration that the bit supporting part has a substantially cylindrical shape having the same outer diameter at the same axial position can have a constant strength in the circumferential direction.

The impact tool of the present disclosure can be configured such that a front end part of the power transmission part is inserted into and connected with a rear end part in the axial direction of the bit supporting part, and the rear end part in the axial direction of the bit supporting part has a size larger in the radial direction than the other part of the bit supporting part.

The bit supporting part having the rear end part in the axial direction which is larger than the other part can more ensure the thickness than the other part, which enables the rotational force from the power transmission part to be securely transmitted to the bit supporting part.

The impact tool of the present embodiment is as described above, but the present invention is not limited to the above embodiment, and can be appropriately modified in design within the intended scope of the present invention. Furthermore, the effects of the present invention are not limited to the above embodiment. In other words, the embodiment disclosed herein should be considered to be illustrative and not restrictive in all respects. The scope of the present invention is indicated by the appended claims rather than by the foregoing description. The scope of the present invention is intended to include all modifications within the meaning and scope equivalent to the claims.

1. An impact tool comprising a motor, a hammer configured to be rotated by the motor, an anvil configured to be struck by the hammer, and a case that houses at least a part of the motor, the hammer, and the anvil,
the anvil comprising a hammer receiving part, a power transmission part, and a bit supporting part or a socket disposed in this order from a rear side to a front side in an axial direction, the hammer receiving part configured to receive an impact from the hammer, the power transmission part configured to transmit a power received by the hammer receiving part to the front side, the bit supporting part or the socket configured to be rotated by receiving the power from the power transmission part,
the bit supporting part and the power transmission part being connected with each other with a play therebetween in a rotational direction.

2. The impact tool according to claim 1, wherein the power transmission part and the bit supporting part or the socket are made of different materials or have different hardnesses.

3. The impact tool according to claim 1, further comprising an intermediate part, wherein
a side surface of the power transmission part and an inner surface of a stationary part located on an outer side in a radial direction of the power transmission part and fixed to the case form therebetween a space for disposing the intermediate part, and
the space comprises a moving area for enabling the intermediate part to move in a circumferential direction, and an engagement area for enabling the intermediate part to be engaged with the side surface of the power transmission part and the inner surface of the stationary part.

4. The impact tool according to claim 1, wherein the bit supporting part has a substantially cylindrical shape having the same outer diameter at the same axial position.

5. The impact tool according to claim 1, wherein a front end part of the power transmission part is inserted into and connected with a rear end part in the axial direction of the bit supporting part, and the rear end part in the axial direction of the bit supporting part has a size larger in the radial direction than the other part of the bit supporting part.
